(19) United States
(12) Patent Application Publication
(10) Pub. No.: US 2012/0049684 A1
(43) Pub. Date: Mar. 1, 2012

(54) MAGNET RING OF A MULTI-POLE GENERATOR FOR A WIND TURBINE

(75) Inventors: Klaus Bodenstein, Hong Kong S.A.R. (CN); Detlef Lange, Oberhausen (DE); Dieter Rupprich, Ohne (DE)

(73) Assignee: AVANTIS LTD., Hong Kong (CN)

(21) Appl. No.: 13/146,011

(22) PCT Filed: Nov. 19, 2009
(86) PCT No.: PCT/EP2009/065443

§ 371 Date: Nov. 3, 2011

(30) Foreign Application Priority Data
Jan. 23, 2009 (DE) 10 2009 006 017.0

(51) Int. Cl. H02K 21/12

(52) U.S. Cl. 310/156.12

(57) ABSTRACT

In the case of a magnet system (1) of a multipole generator, in particular for a wind energy installation or wind power installation, comprising a magnet ring (2, 2′, 2a′-2c′, 2a-2j) having a support (5) on whose external circumference or internal circumference individual permanent magnets (4, 4′) are arranged in one or more rows with a regularly changing polarity alignment, the aim is to provide an assembly capability which makes it possible to equip an external rotor or an internal rotor for a generator of a wind power installation with a multiplicity of individual permanent magnets, which are arranged close to one another, in a manner which is simple and advantageous for assembly. This is achieved in that a plurality of magnet rings (2, 2′, 2a-2j, 2a′-2c′) are joined together at the side, in the axial direction, coaxially and resting on one another, to form a magnet wheel (10).

The invention relates to a magnet system of a multipole generator, in particular for a wind power installation or wind energy installation, comprising a magnet ring having a support on whose external circumference or internal circumference individual permanent magnets are arranged in one or more rows with a regularly changing polarity alignment.

Recently, relatively modern types of wind power installations or wind energy installations have been developed in which the generator is an integral component of the windmill rotor hub, and an internal stator in this case interacts with an external rotor. One such generator is described in DE 102 39 366 A1. In order to form an external rotor such as this, a multiplicity of permanent magnets must be arranged on the inside of the external rotor. This is not without problems, in particular since a generator for a wind energy installation or for a wind power installation has large dimensions. The permanent magnets have a high magnetic force and must be placed accurately in the vicinity of metals. Minor inattention can lead to adjacent permanent magnets attracting one another and for it then to no longer be possible to detach them from one another, or for them jointly also to become fixed on adjacent metal, from which they can likewise no longer be detached.

For relatively small motors, it has been proposed in EP 1 845 604 A2 that a support device composed of plastic, in the form of a tubular support sleeve, be used as a lost aid, as an assembly aid. The individual permanent magnets are placed on the outside of this support sleeve, separated by plastic segments, are adhesively bonded and are then inserted together with the support sleeve into the magnetic return-path tube or the magnetic return-path ring of the external rotor or generator. The support sleeve is then mechanically removed by rotating it out up to the surface of the permanent magnets, as a result of which only the plastic segments which exist between the individual permanent magnets then still remain. A method such as this can be used for small motors but not for generators for wind power installations, which may have a diameter of several metres.

Furthermore, the field system of a multipole generator comprises a plurality of rows of individual permanent magnets which are arranged in an annular shape and are assembled to form a magnet wheel, in order to reduce eddy-current losses, corresponding to the axial overall length and thus the power of the generator, in order to form a magnet system. This magnet wheel has a plurality of magnet segments with alternating polarity alignment along its circumference, such that, when the individual magnet rings are in the assembled position to form the magnet wheel, magnet segments aligned with the same polarity in adjacent rows exert a repulsion force effect on one another. In addition, because of the magnetic forces, the adjacent rows of the individual permanent magnets which are arranged in an annular shape attempt to alignment themselves in a stable north-south position and therefore exhibit the tendency to rotate with respect to one another. The production of a magnet system such as this having a magnet wheel which is produced from a plurality of rows of individual permanent magnets arranged in an annular shape, and in particular the precise alignment of the individual magnet rows with respect to one another, involves a large amount of manufacturing effort.

The invention is based on the object of providing an assembly capability which makes it possible to equip an external rotor or an internal rotor for a generator of a wind power installation with a multiplicity of individual permanent magnets, which are arranged close to one another, in a manner which is simple and advantageous for assembly.

In the case of a magnet system of the type mentioned initially, this object is achieved in that a plurality of magnet rings are joined together at the side, in the axial direction, coaxially and resting on one another, to form a magnet wheel (10).

In order to allow a magnet wheel to be produced overall from the individual magnets, which magnet wheel provides the required number of individual permanent magnets corresponding to the design of the generator, the simple assembly method or simple assembly capability according to the invention is therefore characterized in that individual magnet rings are joined together to form the magnet wheel by stacking them one on top of the other.

In this case, the invention then also provides that the support, in particular in each of its two side surfaces and at regular or irregular angle intervals along its circumference, or the holding elements have guide holes or guide bores, into each of which a first guide section of a guide element is inserted, with a second guide section of the respective guide element being inserted into a corresponding guide hole of an adjacent magnet ring. Adjacent magnet rings can then be formed in layers, and can be arranged such that they can be aligned exactly with respect to one another, with the aid of the guide elements.

In a simple and cost-effective manner, the invention also provides a capability by means of which a magnet wheel which comprises a plurality of magnet rings stacked one on top of the other can be assembled while maintaining a predetermined alignment of the individual permanent magnets and of the magnet segments of adjacent magnet rings with respect to one another. Since the guide elements are inserted into guide holes of mutually adjacent magnet rings, this ensures that the magnet rings are aligned with respect to one another and mutually. There is no need to apply a radial force component during assembly of the individual magnet rings, because the guide elements prevent rotation of the magnet rings. An axial force component on its own is sufficient during assembly which counteracts the magnetic force of the individual mutually repelling individual permanent magnets or magnet segments, because the magnet rings which are arranged adjacent to one another are aligned with respect to one another by means of the guide elements, and misalignment of the magnet rings with respect to one another is impossible, because of this guidance.

In a further refinement of the invention, in order to increase the load capability and the life of the magnet system, adjacent magnet rings are connected to one another by means of an integral connection on their side surfaces which rest on one another, with the integral connection being formed from an anaerobically curing adhesive when mutually adjacent magnet rings are pressed onto one another. During the production of the magnet wheel, the individual magnet rings are pressed onto one another, as a result of which oxygen is drawn out of the adhesive, thus resulting in a high-strength connection in the joint between adjacent magnet rings.

When the materials of those side surfaces of the magnet rings which are to be adhesively bonded to one another are passive with respect to the anaerobically curing adhesive and have no catalytic effect, it is also advantageous if the integral connection is formed from an anaerobically curing adhesive and an activator when adjacent magnet rings are pressed onto one another.

In order to also provide a magnet system having three-dimensionally curved magnet segments or magnet segments arranged obliquely with respect to the magnet system axis, in addition to a magnet system having magnet segments which run parallel to the magnet system axis and have the same polarity alignment, one expedient development of the invention provides that the guide holes or guide bores in all the magnet rings, supports or magnetic return-path rings are formed at the same circumferential position or angle position with respect to individual permanent magnets and/or magnet segments which are arranged along the circumference. In this case, it is then also expedient if the second guide section of the guide elements is laterally offset with respect to the first guide section.

In order to improve the smooth running of the generator and to reduce torque oscillations and the cogging torque, one development of the invention provides that the offset between the first guide section and the second guide section of the respective guide element is designed such that, when the magnet wheel is in the assembled position, the individual permanent magnets and/or the magnet segments with the same polarity alignment are arranged so that they run essentially obliquely or are offset or in the form of a staircase at an angle of 6° to 20° with respect to the magnet wheel axis in the axial direction of magnet ring with respect to the magnet ring.

Furthermore, in a refinement in this case, the lateral offset between the first guide section and the second guide section of the guide elements can be considerably smaller than a circular ring section which is in each case covered by a magnet segment. This measure results in a further increase in life and a better electromechanical operating behaviour of the generator.

Furthermore, one refinement of the invention provides that the magnet wheel is composed of a plurality of magnet rings which are formed in layers on one another and are formed with respect to one another by means of the guide elements.

In order to assemble the individual permanent magnets, the invention provides that the external or the internal circumferential surface, of the support has retaining elements on or in each of which a bracket-like holding element is arranged, with two holding elements, which are arranged at a distance from one another, in each case holding firmly and/or fixing between them an individual permanent magnet on the support.

In a simple and cost-effective manner, the invention therefore provides a capability for assembly of individual permanent magnets, by means of which these individual permanent magnets can be arranged on the rotor, that is to say on the external rotor or internal rotor, of a generator for a wind energy installation or wind power installation. In this case, fundamentally, the invention provides that individual magnet rings are produced first of all and are then joined together to form a magnet wheel with the magnet wheel then being inserted into the pole wheel housing of the generator.

In order to produce the individual magnet rings, a bracket system is provided, in which bracket-like holding elements are inserted into the support, which subsequently forms the magnetic return-path ring of the rotor, and each accommodate one individual permanent magnet between them, and hold it firmly on the support. This is a simple assembly capability which prevents the individual permanent magnets from forming an adhering connection to one another, to the metallic magnetic return-path ring or to the metallic support, at a position other than the intended position. The individual permanent magnets can each be inserted between two holding elements from the side in a simple manner. By way of example, the holding elements comprise a zinc die casting, and ensure the required mechanical robustness of the individual permanent magnets on the support. The individual permanent magnets can then be encapsulated with an adhesive compound or an adhesive, which then provides the required vibration resistance for the magnet ring and the individual permanent magnets arranged on a circular path. In this case, it is particularly advantageous to use an anaerobic adhesive which enters even small capillary openings thus forming a good connection here between the brackets and the individual permanent magnets, but also between the individual permanent magnets and the support, within an interlocking adhesive joint. By way of example, a single individual permanent magnet has a length of 100 mm, thus also essentially governing the axial extent of an individual magnet ring. As will also be evident in conjunction with the further dependent claims, the magnets can be arranged with a relative offset with respect to one another from one magnet ring to another magnet ring, as a result of which the eddy-current losses are reduced by the combination of the relatively small bars and the offset arrangement.

Advantageous and expedient refinements and developments of the invention will become evident from the dependent claims.

For example, the invention is also distinguished in that that each holding element mechanically separates adjacent individual permanent magnets from one another and prevents them from resting directly on one another.

In order to allow the desired simple assembly to be achieved particularly advantageously, one development of the invention also provides that adjacent holding elements are arranged at a distance and the individual permanent magnets are designed such that one individual permanent magnet can in each case be inserted at the side, in the axial direction of the support, into the intermediate space which is formed between adjacent holding elements.

Since the individual permanent magnets are intended to physically relatively small, it is advantageous for a plurality of individual permanent magnets which are aligned with the same polarity and are arranged alongside one another each to be joined together to form a magnet segment, and this is likewise envisaged by the invention.

In order to avoid using too many components and then possibly having to remove them again as lost aids, it is also advantageous if the support is or forms a magnetic return-path ring, and this is likewise envisaged by the invention.

One particularly suitable material from which individual permanent magnets can be produced is metals from the rare earths. The invention is therefore also distinguished in that the individual permanent magnets are produced from a metal from the rare earths.

A particularly advantageous arrangement and alignment of the individual permanent magnets with respect to the magnet wheel axis can be achieved, according to a further refinement of the invention, in that the retaining elements runs obliquely inclined, in particular at an angle of 6° to 20°.

Finally, the invention also provides that the magnet wheel is connected to a pole wheel housing integrally and/or in a force-fitting manner along a circumferential retaining surface by means of a shrink-adhesion joint. This measure allows the magnet wheel, the production of which is complete, to be fitted into or onto a retaining surface of a pole wheel housing in a manner which is simple and advantageous for assembly, thus then making it possible to produce a magnet system which is used in conjunction with a generator for a wind power installation or wind energy installation. The retaining surface of the pole wheel housing may be both an inner circumferential surface and a circumferential surface formed on the outside of the pole wheel.

A magnet system having three-dimensionally curved magnet segments or magnet segments which run obliquely with respect to the magnet system axis can also be provided by designing the guide holes, which are formed in a side surface of each magnet ring, to be offset with respect to those in a side surface of an adjacent magnet ring, with respect to the magnet segments which are arranged all around the circumference of the magnet rings.

In order to improve the smooth running while at the same reducing the torque fluctuations and the cogging torque, it is also possible to design the offset between the guide holes in the two mutually adjacent magnet rings such that, when the magnet system or the magnet wheel is in the assembled position, the magnet systems with the same polarity alignment of the individual magnet rings are arranged such that they run essentially obliquely, at an angle of 6° to 20°, with respect to the magnet ring axis in the axial direction.

The advantageous effect described above can also be achieved by designing the offset between the guide holes in the two mutually adjacent magnet rings such that, when the magnet system or the magnet wheel is in the assembled position, the magnet signals with the same polarity alignment of the individual magnet rings are arranged offset in the form of a staircase with respect to the magnet ring axis in the axial direction, and such that the offset between the guide holes in the two mutually adjacent magnet rings in the circumferential direction of the magnet rings is considerably smaller than a circular section of a respective magnet segment.

In order to guide the magnetic lines of force of the individual magnet segments of the respective magnet rings and in order to magnetically screen the magnet system, a magnetic return-path ring can be fitted on the external circumference or the internal circumference of the respective magnet rings.

It is therefore possible according to the invention for the magnet rings, when in the assembled position, to form an external rotor or an internal rotor of the generator for the wind energy installation.

Since the magnet segments are electrically conductive, eddy-current losses occur in them, during operation of the generator. The eddy-current losses become greater the larger the pole area of an individual magnet segment is. In order to minimize these eddy-current losses, the individual magnet segments may each have a plurality of, preferably three, individual permanent magnets which are aligned with the same polarity and are attached to and/or mounted in a magnetic return-path ring of a respective magnet ring by means of holding elements. In consequence, there are essentially no gaps between the individual magnet segments.

The respective individual permanent magnets are expediently produced from a metal from the rare earths.

It is self-evident that the features mentioned above and those which are still to be explained in the following text can be used not only in the respectively stated combination but also in other combinations. The scope of the invention is defined only by the claims.

Further details, features and advantages of the subject matter of the invention will become evident from the following description in conjunction with the drawing, which illustrates, by way of example, one preferred exemplary embodiment of the invention, and in which:

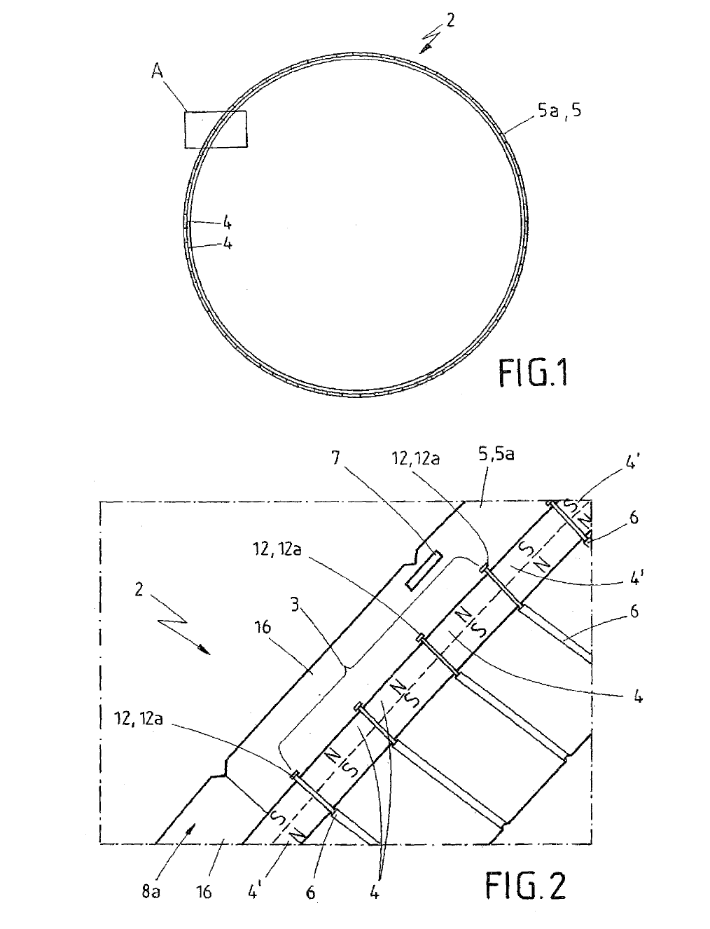

FIG. 1 shows a schematic illustration, in the form of a plan view, of a magnet ring,

FIG. 2 shows an enlarged illustration of the detail A from FIG. 1,

FIG. 3 shows a perspective, schematic illustration of a plurality of magnet rings before being assembled to form a magnet wheel,

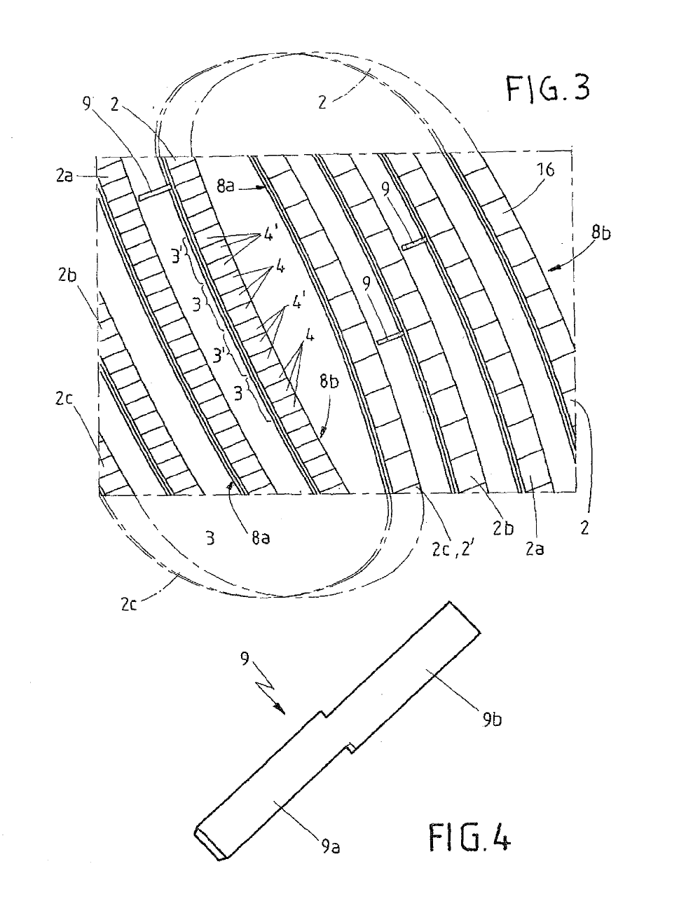

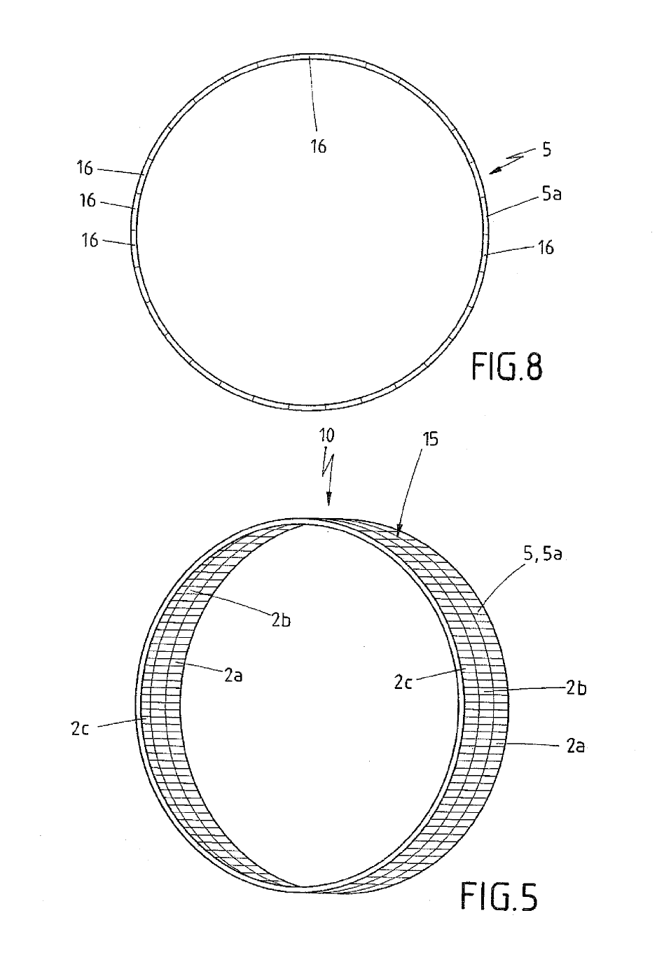

FIG. 4 shows a schematic illustration of a guide element,

FIG. 5 shows a schematic perspective illustration of a magnet wheel which has been assembled from a plurality of magnet rings,

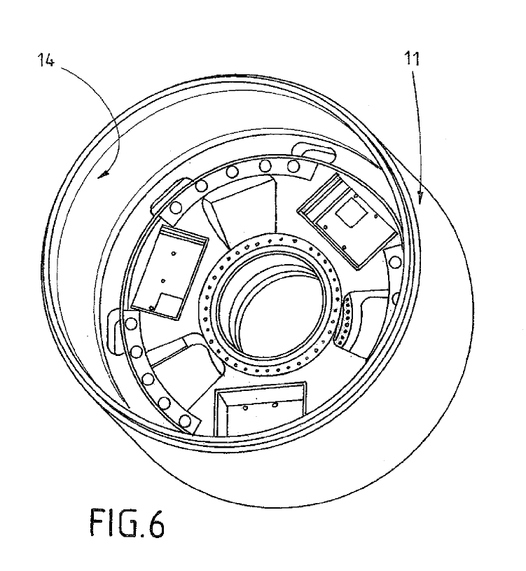

FIG. 6 shows a pole wheel housing having a retaining surface for a magnet wheel,

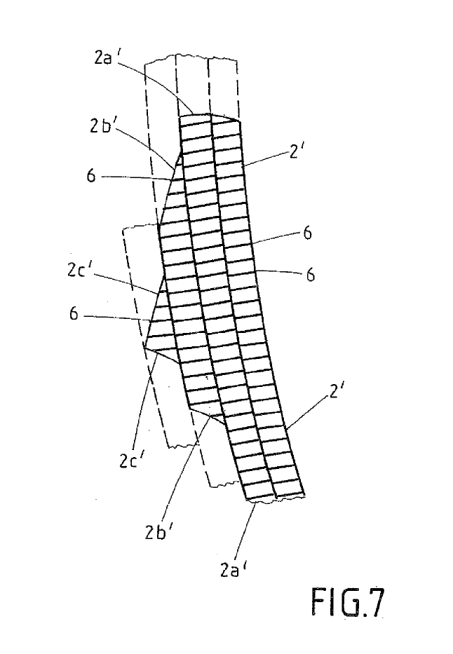

FIG. 7 shows an alternative embodiment of a magnet arrangement, in the form of a partial view, and

FIG. 8 shows a magnetic return-path ring.

A wind energy installation or wind power installation essentially comprises a rotor with a hub and rotor blades and a machine pod, which surrounds the generator. By way of example, the mechanical power which is produced by means of the rotor blades is converted to electrical power by means of a multipole generator, preferably a synchronous generator, which is operated at the same rotation speed as the rotor and is accommodated in the machine pod. A multipole generator such as this has a stator with windings and a rotor which surrounds the stator (external rotor) or a rotor which is surrounded by the stator (internal rotor).

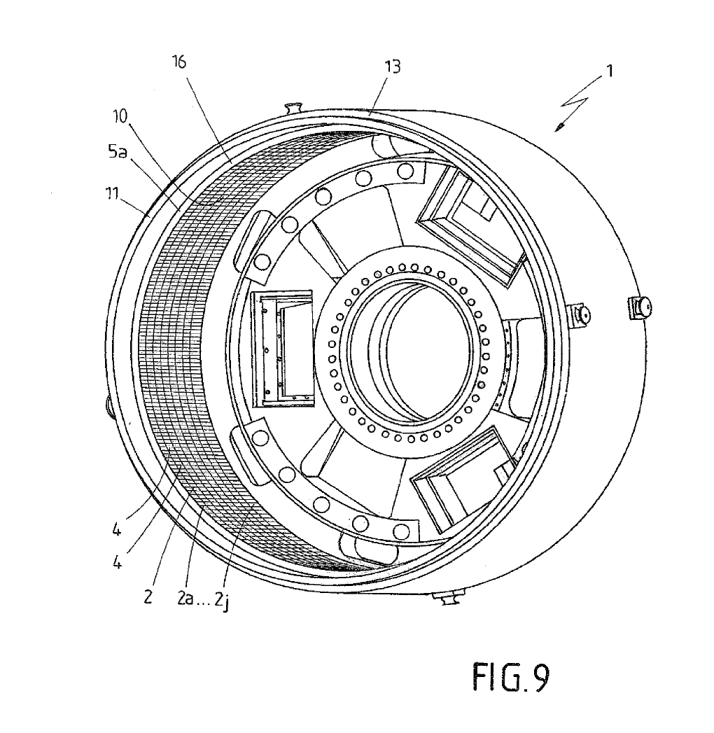

The exemplary embodiment represents an external rotor which forms a magnet system 1, which is illustrated in FIG. 9 and comprises a plurality of magnet rings 2, 2a-2j, 2′, 2a′, 2b′, 2c′ which are assembled to form a magnet wheel 10 which is installed in a pole wheel housing 11, on the inside of a retaining surface 14. Each magnet ring 2, 2a-2j, 2′, 2a′, 2b′, 2c′ has a multiplicity of individual permanent magnets 4, 4′ which are arranged around the circumference of the respective magnet ring, with three individual permanent magnets 4, 4′, which are arranged alongside one another and are aligned with the same polarity, in each case forming a magnet segment 3, 3′. The magnet segments 3, 3′ are themselves arranged alongside one another with alternating polarity alignment, as can be seen in FIG. 2. In this case, the south pole S and the north pole N are each aligned in the radial direction, as a result of which a magnet segment 3 with an external north-pole area and an internal south-pole area and a magnet segment 3′ with an external south-pole area and an internal north-pole area in each case follow one another alternately in the circumferential direction. Each magnet segment 3, 3′ itself comprises a plurality of individual permanent magnets 4, 4′ which are arranged alongside one another on the longitudinal side, in each case aligned with the same polarity, in order to reduce the eddy-current losses which would otherwise be very high with large pole areas. In the exemplary embodiment, a magnet segment 3, 3′ is in each case composed of three individual permanent magnets 4, 4′. However, magnet segments 3, 3′ with a different number of individual permanent magnets 4, 4′ to this are also feasible. The individual permanent magnets 4, 4′ are produced from a metal from the rare earths, in particular from a high-permeability, sintered metal power using these metals.

The gaps between each of the adjacent individual permanent magnets 4, 4′ are kept as small as possible in order to optimize the performance of a generator which has a rotor with a magnet wheel 10. For this purpose, the individual permanent magnets 4, 4′ are inserted on the inside into a support 5 which forms a magnetic return-path ring 5a, with the magnetic return-path ring 5a that has been equipped with the individual permanent magnets 4, 4′ then in each case forming a magnet ring 2, 2′, 2a′-2c′, 2a-2j.

The magnetic return-path ring 5a is composed of individual metal segments 16 which, resting on one another, form the magnetic return-path ring 5a which is in the form of a circular ring. The individual metal segments 16 can be connected to one another via connecting lugs, and can be welded to one another. In particular, they are pressed together with a force fit when the magnetic return-path ring 5a is inserted with the individual permanent magnets 4, 4′ inserted in it into the pole wheel housing 11, and is then pressed together along the retaining surface 14 as the heated pole wheel housing 11 cools down, as will be explained in the following text.

In order to allow the individual permanent magnets 4, 4′ to be arranged at as short a distance from one another as possible on the magnetic return-path ring 5a during assembly, the magnetic return-path ring 5a is provided with retaining elements 12 in the form of slots 12a, which are in the form of grooves, run in the axial direction and are distributed uniformly over its internal circumferential surface, at a distance corresponding to the width of an individual permanent magnet 4, 4′. A holding element 6 which has a double-T-shaped cross section and acts as a bracket is inserted into each of these slots 12a which are in the form of grooves. One individual permanent magnet 4, 4′ is then arranged between in each case two holding elements 6 and is fixed by the holding elements 6 on the inside of the magnetic return-path ring 5a. In this case, the holding elements 6 have a very small thickness extent, as a result of which there is only an extremely narrow gap between mutually adjacent individual permanent magnets 4, 4′. The magnetic return-path ring 5a is of such a strength or thickness that it is no longer possible to detect any magnetic force on its outside when individual permanent magnets 4, 4′ are fitted on its inside and, in consequence, there is no externally acting magnetic force. A steel material with as high a component of iron as possible and a small component of alloying elements is preferably used to produce the magnetic return-path ring 5a or the metal segments 16.

As is indicated by the holding elements 6 inserted therein in FIG. 7, the retaining elements 12 can easily be aligned slightly inclined obliquely with a gradient of 6°-20°. The retaining elements 12 may also be in the form of rails.

The dimensions of the magnetic return-path ring 5a, the magnet segments 3, 3′ and the individual permanent magnets 4, 4′ are matched to one another such that they result in an even number of magnet segments 3, 3′ distributed uniformly around the internal circumference of the magnetic return-path ring 5a, with magnet segments 3, 3′ with the same or identically aligned polarity then in each case being diametrically opposite. The assembly procedure is now carried out such that the magnet segments 3 with the same polarity alignment are first of all arranged on the inside on the magnetic return-path ring 5a between the individual holding elements 6, and only then are the magnet segments 3′ with the polarity aligned in the opposite direction inserted into the intermediate spaces which then exist. During this process, the holding elements 6 form separating walls and guide rails between individual permanent magnets 4, 4′ which in each case rest on one another, in such a way that, both in the case of a repelling polarity arranged in the same direction and in the case of an attracting polarity, a respective individual permanent magnet 4, 4′ can be reliably inserted, guided between two holding elements 6, in the axial direction of the magnetic return-path ring 5a into its respectively intended position.

The magnetic return-path ring 5a is designed with thin walls and is composed of individual laminated segments 16.

A plurality of the magnet rings 2, 2′, 2a-2j, 2a′, 2b′, 2c′, which each comprise a magnetic return-path ring 5a with individual permanent magnets 4, 4′ inserted in them, are assembled to form a magnet wheel 10, corresponding to the respectively desired and intended power of the generator or the pole wheel that is equipped in this way. For this purpose, the individual magnet rings 2, 2′, 2a′-2c′, 2a-2j are placed on one another at the sides, piece by piece, in the axial direction of the magnet wheel 10 until the desired number of magnet rings have been formed. In the case of the pole wheel housing 11 which is illustrated in FIG. 9 and is equipped with a magnet wheel 10, eleven magnet rings 2-2j are arranged in a row in order to form the magnet wheel 10. When the individual magnet rings are in the assembled position to form the magnet wheel 10, magnet segments 3, 3′ of the same polarity, and therefore repelling poles of the individual permanent magnets 4, 4′ in this case rest on one another, at least in places, in the axial direction of the magnet wheel 10. The magnet segments 3, 3′ which rest on one another with the same polarity of mutually adjacent magnet rings 2, 2′, 2a-2j, 2a′-2c′ therefore result in a repulsion force effect in the axial direction during the assembly of the magnet wheel 10, that is to say in the direction parallel to the magnet ring axis or magnet wheel axis. In this case, and additionally, because of the magnetic forces of the magnet segments 3, 3′ with the same polarity or the same polarity alignment, the magnet rings which in each case rest on one another attempt to align themselves in a stable north-south position, that is to say to rotate so far relative to one another that attracting magnet segments 3, 3′ with an opposite polarity alignment in each case rest on one another. In order to ensure that this is not possible, the magnet rings 2, 2′, 2a′-2c′, 2a-2j must be guided while being assembled to form a magnet wheel 10, and must be held in their relative position with respect to one another. For this purpose a plurality of guide holes 7 are formed uniformly along the circumference in each of the two side surfaces 8a, 8b in each magnetic return-path ring 5a of a respective magnet ring. The guide holes 7 may be formed either at regular or at irregular angular intervals along the circumference in the respective side surface 8a, 8b. The only important factor is that the guide holes 7 which are formed in magnet rings 2 which are arranged adjacent to one another in the installed state are aligned or can be aligned to correspond to one another, that is to say aligned or with an offset with respect to one another which is bridged by a guide element 9 when the respective magnet rings are in the assembled state. During assembly of the magnet wheel 10, the first guide section 9a of a guide element 9 which is in the form of a rod or bar is in each case inserted into a respective guide hole 7, which may also be a blind hole. A second guide section 9b of the guide element 9 then projects out of this guide hole 7 in the magnet ring 7 and is used to guide a further magnet ring, which can be stacked on the respective magnet ring. For this purpose, the second guide section 9b is inserted into a guide hole 7, which corresponds to the guide hole 7, in the magnet ring to be stacked on it, for example the magnet ring 2a, such that the magnet ring 2a to be stacked on it can be pressed against the magnet ring 2 in an aligned position, without any mutual rotation occurring between the two magnet rings 2, 2a as a result of the magnetic forces that act. Mutually adjacent magnet rings, for example the magnet rings 2 and 2a, can therefore be formed in layers on one another and can be aligned with respect to one another by means of the guide elements 9.

In this case, the mutually adjacent magnet rings 2, 2′, 2a′-2c′, 2a-2j are attached to the corresponding side surfaces 8a, 8b by means of an integral joint, with these side surfaces 8a, 8b comprising the side surfaces of the magnetic return-path ring 5a and of the individual permanent magnets 4, 4′. For this purpose, and before the individual magnet rings are stacked, at least one of the mutually adjacent side surfaces 8a or 8b of a magnet ring is coated with an anaerobically curing adhesive, which forms the integral joint to the magnet ring 2, 2′ adjacent to it. The adhesive is an anaerobically curing adhesive in the form of a single-component adhesive, which cures with oxygen being excluded. The curer component contained in the adhesive remains inactive as long as it is in contact with the oxygen in the air. As soon as the adhesive is separated from the oxygen, as is the case when two magnet rings are stacked one on top of the other and the side surfaces 8a, 8b which rest on one another are then pressed onto one another, the curing process takes place very quickly, in particular when there is metal contact at the same time. Even the very small intermediate spaces in the joint area are filled by the capillary effect of the liquid adhesive. The cured adhesive is then anchored in the depressions in the roughness of those side surfaces 8a, 8b of the mutually adjacent magnet rings which are to be connected. The curing process is initiated by the contact of the adhesive with the metal surfaces of the two side surfaces 8a, 8b of the mutually adjacent metal rings, such that the metal surfaces then act as a catalyst.

For the situation in which the side surfaces 8a, 8b of the magnet rings are composed of a non-metallic material, that is to say a material which is passive for the adhesive bonding process, an activator can be applied, before the coating process with the anaerobically curing adhesive, to at least one of the two side surfaces 8a, 8b, which are arranged adjacent to one another, of the magnet rings to be connected to one another. The application of an activator is recommended because passive materials such as these have only a minor catalytic effect, or none at all, as is necessary for curing of the anaerobic adhesive. Use of an activator is also recommended in order to avoid lack of correct adhesion when using metals with high passive characteristics, such as chromium and stainless steel. Adhesive bonding of this type additionally seals the connection point against corrosive media. Furthermore, an anaerobically curing adhesive such as this has good resistance to mechanical vibration, and good resistance to dynamic fatigue loads.

The use of an anaerobically curing adhesive with or without an activator ensures that the curing process in the joint between the respective magnet rings starts only after contact between two magnet rings.

In the case of the exemplary embodiment described above, the guide holes 7 which are formed in the side surfaces 8a, 8b of a respective magnet ring 2, 2′, 2a-2j, 2a′-2c′ are formed at the same circumferential position, on all the magnet rings, with respect to the magnet segments 3, 3′ which are arranged around the circumference of a magnet ring. This then results in a magnet wheel 10 which is formed from layers or a stack of a plurality of magnet rings, with magnet segments 3, 3′ which are arranged parallel to the magnet ring axis or magnet wheel axis or magnet system axis, with magnet segments of the same polarity alignment being arranged in a row in a line. In consequence, the holding elements 6 form a line which runs straight and parallel to the magnet wheel longitudinal axis from one individual permanent magnet 4, 4′ to another individual permanent magnet 4, 4′ of magnet rings which rest on one another, as is illustrated in FIG. 9 for a magnet wheel 10, which comprises eleven magnet rings 2-2j, for the magnet system 1.

In order to provide a magnet wheel system 10 with three-dimensionally curved magnet segments 3, 3′ which run obliquely with respect to the magnet wheel axis, as is illustrated schematically in FIG. 7, a second exemplary embodiment provides that the second guide section 9b is formed laterally offset with respect to the first guide section 9a of the respective guide element 9 in the circumferential direction of the respective magnet rings. FIG. 4 illustrates one such guide element 9. In this case, the offset between the first guide section 9a and the second guide section 9b of the guide element 9 is designed such that, when a magnet wheel 10 is in the assembled position, the magnet segments 3, 3′ and/or the individual permanent magnets 4, 4′ on the individual magnet rings are each arranged offset with respect to one another from one magnet ring to another magnet ring in the axial direction, in the direction of the magnet ring axis. In this case, the offset between the first guide section 9a and the second guide section 9b of the respective guide element 9 can be designed such that, when the magnet wheel 10 is in the assembled position, the magnet sections 3, 3′ which are associated with one another and have the same polarity alignment of the individual magnet rings are arranged offset in the form of a staircase in the axial direction with respect to the magnet ring axis. Whether the separating line which is formed between the individual permanent magnets 4, 4′ by the holding elements 6 runs parallel or inclined, in particular at an angle of 6°-20° with respect to the magnet wheel axis or magnet ring axis, is in this case governed by the alignment of the retaining elements 12, which governs this. The offset between the first guide section 9a and the second guide section 9b of the guide element 9 in the circumferential direction of the magnet rings may in this case be considerably smaller than a circular section of one respective magnet segment 3. Alternatively, however, it is also possible for the slots 12 which are in the form of grooves to be inclined obliquely and for a correspondingly obliquely aligned arrangement of the individual permanent magnets 4, 4′ to be produced by appropriate geometric configuration of the individual permanent magnets 4, 4′.

A magnet wheel 10 having three-dimensionally curved side edges/side surfaces, which run obliquely with respect to the magnet system axis, of the magnet segments 3, 3′ may also be provided with a guide element 9 in the form of a rod, without offset first and second guide sections 9a, 9b, in which guide element 9, according to a further exemplary embodiment, the guide holes 7, which are formed in mutually associated side surfaces 8a, 8b of a respective magnet ring, are offset with respect to the magnet segments 3 which are in each case arranged around the circumference of the magnet rings, that is to say have a different relative position with respect to the retaining elements 12 on each of the two side surfaces 8a, 8b. The offset between the guide holes 7 in the mutually facing side surfaces 8a, 8b of adjacent magnet rings can once again be designed such that when the magnet wheel 10 is in the assembled position, the magnet segments 3, 3′ with the same polarity alignment from one magnet ring to another magnet ring are arranged such that they run essentially obliquely at an angle of 6° to 20° with respect to the magnet ring axis in the axial direction. However, alternatively, it is also once again feasible for the offset between the guide holes 7 of respectively adjacent magnet rings to be designed such that, when the magnet wheel 10 is in the assembled position, the magnet segments 3, 3′ with the same polarity alignment from one magnet ring to another magnet ring are arranged offset in the form of a staircase with respect to the magnet ring axis in the axial direction. The offset between the guide holes 7 of adjacent magnet rings in the circumferential direction of the magnet rings may be considerably less than a circular section of a respective magnet segment.

Therefore, overall, there are various design options for the alignment of the individual permanent magnets 4, 4′ and of the magnet segments 3, 3′ both in each case in a single magnet ring and in their alignment from one magnet ring to another magnet ring, for magnet rings which are assembled to form a magnet wheel 10. In order to align the individual permanent magnets 4, 4′ on the respective support 5 at right angles to the side edge of the annular support 5 or parallel to the magnet ring axis, it is possible to appropriately align the retaining elements 12 and therefore the holding elements 6 which are held and guided therein. Rectangular, cuboid individual permanent magnets 4, 4′ can then be inserted from the side between two holding elements 6. If the intention is to arrange individual magnet segments 4, 4′ which are arranged obliquely inclined on a support 5, then this can be done by forming and arranging the retaining elements 12 of the support 5, and in consequence the holding elements 6 which are arranged therein or thereon, with a corresponding inclination of 6°-20° with respect to the magnet ring axis or magnet wheel axis which runs through the magnet ring centre point. A cuboid, which is in the form of a parallelogram when seen in a plan view, of an individual permanent magnet 4, 4′ can then be arranged between two holding elements 6. In the case of magnet rings which rest on one another, the relative position of the individual permanent magnets 4, 4′ with respect to one another from one magnet ring to another magnet ring can be fixed in a variable form by the corresponding embodiment of the guide holes 7 in the respective side surfaces 8a, 8b and the configuration of the guide elements 9. It is therefore possible for the individual permanent magnets 4, 4′ to each be arranged offset with respect to one another from one magnet ring to another magnet ring, and for the holding elements 6 likewise to have a stepped offset from one magnet ring to another magnet ring. However, it is also possible to arrange the individual magnet segments 4, 4′ in a linear form in a row with respect to one another, such that the holding elements 6 which have been arranged in a row then form a continuous line in the magnet ring 10, which is inclined obliquely, aligned at an angle of 6°-20° or else in a straight line, that is to say parallel to the magnet wheel axis which runs through the magnet wheel centre point.

The exemplary embodiments described above relate to a magnet system 1 for an external rotor. However, a person skilled in the art will see that the features described above can also be transferred by a simple modification to an internal rotor, in particular to an internal rotor of a generator for a wind energy installation, in which case the magnetic return-path ring no longer screens the external circumference but the internal circumference of a magnet ring, and for this purpose is essentially formed on the internal circumference of a respective magnet ring.

In order to increase the magnetic pole sensitivity, which results in conjunction with a slotted armature of a machine, a laminated armature core must be laminated such that the slots run obliquely with respect to the centre axis. This makes it more difficult to use windings composed of rectangular coils, which are required to maximize the utilization of the machine. In order to allow a non-skewed armature to be used, however, the magnet system 1 or a magnet wheel 10 must be inclined, which is impossible when using simple rectangular magnet segments 3, 3′. However, the same effect can be achieved by using guide elements with discontinuities or steps, or those with offset guide sections 9a, 9b, instead of straight guide elements 9, as is illustrated in FIG. 4. This results in a magnet system 1 with magnet rings 2′, 2a′-2c′ which are offset in the form of a staircase, which is electrically equivalent to skewing, and is illustrated schematically in FIG. 7.

Overall, the invention provides a magnet system 1, which comprises a pole wheel 13, of an external rotor type, which comprises a magnet wheel 10 which is formed from individual magnet rings 2, 2′, 2a, 2b, 2c, 2d, 2e, 2f, 2g, 2h, 2i, 2j, 2a′-2c with a plurality of magnetized magnet segments 3, 3′ of alternating polarity, which pole wheel 13 can be used for a generator in a wind energy installation.

Although the described magnet system may have similarities to apparatuses which are known per se, it is particularly significant here that a magnet system such as this is also used in the field of highly loaded components of wind energy installations, and can be used successfully in this case.

The magnet system 1, which comprises the pole wheel housing 11 with the magnet wheel 10 inserted in it, therefore comprises individual magnet rings, which may be electrically insulated from one another as a result of the connection by means of an adhesive, and which are stacked corresponding to the axial overall length of the magnet wheel 10 to form a core, and form a thin-walled magnetic return-path ring 5a for guidance of the magnetic lines of force and for external screening. The core is also provided with its mechanical strength by means of holders by struts or guide elements 9, which are preferably welded-in in magnetically unloaded zones.

The annular magnet wheel 10, which comprises a plurality of magnet rings, is connected during the production of the pole wheel 13 to the pole wheel housing 11, which is illustrated in FIG. 6, with the magnet wheel 10 being fitted internally in the pole wheel housing 11. In order to save weight, the pole wheel housing 11 may be composed of a non-magnetic material. A retaining surface 14 is formed in the internal circumference of the pole wheel housing 11. The retaining surface 14 may, for example, be a minimal depression or indentation, which is matched to the geometric dimensions of the magnet wheel 10, in order to form a connection to the pole wheel housing 11.

In order to produce the pole wheel, the pole wheel housing 11 is heated slightly, in a first step, in order to allow the pole wheel housing 11 and the magnet wheel 10 to be joined. The pole wheel housing 11 is heated to a temperature at which the internal diameter of the pole wheel housing 11, in particular the diameter of the retaining surface 14, expands to a diameter which is greater than the external diameter of the magnet wheel 10.

In a step which follows the heating of the pole wheel housing 11, the magnet wheel 10 is then arranged in or on the retaining surface 14 which is formed in the internal circumferential surface of the pole wheel housing 11.

In a step which follows this, the pole wheel housing 11 is cooled down, or the pole wheel housing is allowed to cool down such that the pole wheel housing 11 is shrunk onto the magnet wheel 10. The shrinking process is therefore based on the principle of thermal expansion, in which the two parts to be connected to one another are not manufactured with an accurate fit, but the pole wheel housing 11 is manufactured to be slightly too small and the magnet wheel 10 to be slightly too large, which means that the two parts cannot be connected to one another at a normal temperature, that is to say in general at room temperature or ambient temperature. The respectively heated item expands by heating, and then shrinks again when it cools down. As it cools down, the pole wheel housing 11 therefore shrinks, and is pressed onto the magnet wheel 10. By way of example, the pole wheel housing 11 can be cooled down in an ambient temperature environment.

In one step of the method, the external circumferential surface of the magnet wheel 10, that is to say the outside of the magnet return-path ring 5a, is coated with an adhesive 15. Alternatively, however, the retaining surface 14 of the pole wheel housing 11 can also be coated with an adhesive. It is furthermore also feasible for both the external circumferential surface of the magnet wheel 10 and the retaining surface 4 of the pole wheel housing 11 to be coated with an adhesive. The coating of the external circumferential surface of the magnet wheel 10 or of the retaining surface 4 of the pole wheel housing 11, or of both surfaces jointly, can in this case be carried out at very different times while carrying out the joining process to connect these two components. For example, the coating can be carried out before the heating of the pole wheel housing 11, before the arrangement of the magnet wheel 10, or before the pole wheel housing 11 has been cooled down.

The adhesive which is used during the coating process is likewise an aerobically curing adhesive in the form of a single-component adhesive, which cures at room temperature, with oxygen being excluded. The curing component which is contained in the liquid adhesive remains inactive as long as it is in contact with the oxygen in the air. As soon as the adhesive 15 is excluded from oxygen, as is the case during the process of joining or shrinking the pole wheel housing 11 onto the magnet wheel 10, the curing process takes place very quickly, in particular with metal contact at the same time. Even very small intermediate spaces in the joint area are filled by the capillary effect of the liquid adhesive 15. The cured adhesive is then anchored in the depressions in the roughness of the parts to be connected. The curing process is initiated by the contact of the adhesive 15 with the metal surfaces of the pole wheel housing 11 and the magnet wheel 10, as a result of which these metal surfaces accordingly act as a catalyst. Metallic materials can thus be adhesively bonded to one another.

For the situation in which the pole wheel housing 11 is composed of a non-metallic material, that is to say a material which is initially passive for the adhesive bonding process, an activator can be applied to the retaining surface 14 of the pole wheel housing 11 before coating with the anaerobically curing adhesive 15. If the external circumferential surface of the magnet wheel 10 has a layer of non-metallic material, then this surface can also be coated with an activator. The application of an activator is recommended because passive materials have only a slight catalytic effect, or no catalytic effect at all, and this is required for curing of the anaerobic adhesive. The use of an activator is also recommended, in order to avoid incorrect adhesive joints, in the case of metals with high passive characteristics, such as chromium and stainless steel. An adhesive joint of this type additionally seals the connection point of the pole wheel housing 11 and the magnet wheel 10 against corrosive media. Furthermore, an anaerobically curing adhesive 15 such as this has very good resistance to mechanical vibration, and good resistance to dynamic fatigue loads.

Irrespective of whether or not an activator is used, the method may have an additional step, in which, before the arrangement of the magnet wheel 10, the external circumferential surface of the magnet wheel 10, that is to say the external surface of the magnetic return-path ring 5a, or the retaining surface 14 of the pole wheel housing 11, is roughened by means of sand blasting or shot blasting. However, it is also feasible for both surfaces to be roughened by means of sand blasting or shot blasting. This measure improves the adhesion of the adhesive 15 and the load capability of the joint which is formed between the pole wheel housing 11 and the metal wheel formed from magnetic return-path rings 5a.

In consequence, the method described above combines an adhesive process and a pressing process as the pole wheel housing 11 cools down, which jointly and simultaneously produce their effect, in order to create the connection between the pole wheel housing 11 and the magnet wheel 10. As the pole wheel housing 11 cools down, it surrounds the magnet wheel 10 with slight pressure in the form of a force fit, with the adhesive connection resulting in an integral joint. In this case, a retaining surface 14, which is in a recessed form with a side edge, can also contribute interlocking components. In any case, this prevents the adhesive 15 which is located between the external circumferential surface of the magnet wheel 10 and the retaining surface 14 of the pole wheel housing 11 from having any contact with oxygen, as a result of which it can cure, resulting in a high-strength connection, in the form of an integral joint. The cooling down of the pole wheel housing 11 and the surrounding of the magnet wheel 10 linked to this result in the individual permanent magnets 4, 4′ and the individual magnet segments 3, 3′ of the magnet wheel 10 being pressed against one another and/or against the holding elements 6. The individual metal segments 16 of the support 5 are likewise forced or pressed against one another. All these elements therefore additionally form a joint between themselves, in the form of a force fit. When the pole wheel housing 11 cools down and is shrunk onto the magnet wheel 10, this therefore produces an integral connection between the pole wheel housing 11 and the magnet wheel 10, and an at least force-fitting connection between the individual magnet segments 3, 3′ or the individual permanent magnets 4, 4′ of the magnet wheel 10, or between these elements and the respective holding element 6 resting thereon, thus, together with the pole wheel housing 11, forming the magnet system 1.

In order to avoid using excessive adhesive 15, for financial reasons, it is recommended that the adhesive which emerges from the connecting joint formed between the magnet wheel 10 and the pole wheel housing 11 be sucked out and be used.

Therefore, overall, this provides a method for production of a pole wheel 13 of the external-rotor type by means of a “shrink-adhesion joint”, which has integral and force-fitting connections between the pole wheel housing 11 and the magnet wheel 10, and between the individual magnet segments 3, 3′ and/or the individual permanent magnets 4, 4′ and the holding elements 6 of the magnet wheel 10. The “shrink-adhesion joint” results in a considerable improvement with respect to any shear forces and bending moments that occur, with the connected components being connected to one another over the entire length such that it is virtually impossible to detach them.

A pole wheel 13 of the external-rotor type produced using this method and having a magnet wheel 10 with a plurality of magnetized magnet segments 3, 3′ of alternating polarity alignment and having a pole wheel housing 11 can be used for a generator for a wind energy installation.

Although the described method may have similarities with methods which are known per se, it is particularly important here that a method such as this for production of an adhesive joint and shrunk joint are also used in the field of highly loaded components of wind energy installations, and can be used successfully in this case.

1. A Magnet system of a multipole generator comprising a magnet ring having a support on whose external circumference or internal circumference individual permanent magnets are arranged in one or more rows with a regularly changing polarity alignment, wherein a plurality of magnet rings are joined together at the side, in the axial direction, coaxially and resting on one another, to form a magnet wheel.

2. The Magnet system according to claim 1, wherein the support or the holding elements have guide holes or guide bores, into each of which a first guide section of a guide element is inserted, with a second guide section of the respective guide element being inserted into a corresponding guide hole or a guide bore of an adjacent magnet ring.

3. The Magnet system according to claim 1, wherein adjacent magnet rings are connected to one another by means of an integral connection on their side surfaces which rest on one another, with the integral connection being formed from an anaerobically curing adhesive when mutually adjacent magnet rings are pressed onto one another.

4. The Magnet system according to claim 3, wherein the integral connection is formed from an anaerobically curing adhesive and an activator when adjacent magnet rings are pressed onto one another.

5. The Magnet system according to claim 2, wherein, the guide holes or guide bores in all the magnet rings, supports or magnetic return-path rings are formed at the same circumferential position or angle position with respect to individual permanent magnets and/or magnet segments which are arranged along the circumference.

6. The Magnet system according to claim 2, wherein the second guide section of the guide elements is laterally offset with respect to the first guide section.

7. The Magnet system according claim 6, wherein the offset between the first guide section and the second guide section is designed such that, when the magnet wheel is in the assembled position, the individual permanent magnets and/or the magnet segments with the same polarity alignment are arranged so that they run essentially obliquely or are offset in the form of a staircase at an angle of 6° to 20° with respect to the magnet wheel axis in the axial direction of magnet ring with respect to the magnet ring.

8. The Magnet system according to claim 7, wherein the lateral offset between the first guide section and the second guide section of the guide elements is considerably smaller than a circular ring section which is in each case covered by a magnet segment.

9. The Magnet system according to claim 2, wherein the magnet wheel is composed of a plurality of magnet rings which are formed in layers on one another and are aligned with respect to one another by means of the guide elements.

10. The Magnet system according to claim 1, wherein the external or the internal circumferential surface of the support has retaining elements in or on each of which a bracket-like holding element is arranged, with two holding elements, which are arranged at a distance from one another, in each case holding firmly and/or fixing between them an individual permanent magnet on the support.

11. The Magnet system according to claim 10, wherein each holding element mechanically separates adjacent individual permanent magnets from one another and prevents them from resting directly on one another.

12. The Magnet system according to claim 10, wherein adjacent holding elements are arranged at a distance and the individual permanent magnets are designed such that one individual permanent magnet can in each case be inserted at the side, in the axial direction of the support, into the intermediate space which is formed between adjacent holding elements.

13. The Magnet system according to claim 10, wherein a plurality of individual permanent magnets which are aligned with the same polarity and are arranged alongside one another each form a magnet segment.

14. The Magnet system according to claim 10, wherein the support forms a magnetic return-path ring.

15. The Magnet system according to claim 10, wherein the individual permanent magnets are produced from a metal from the rare earths.

16. The Magnet system according to claim 10, wherein the retaining elements run obliquely inclined, in particular at an angle of 6°-20°.

17. The Magnet system according to claim 1, wherein the magnet wheel is connected to a pole wheel housing integrally and/or in a force-fitting manner along a circumferential retaining surface by means of a shrink-adhesion joint.

18. The Magnet system of a multipole generator according to claim 1, wherein the multipole generator comprises a wind energy installation or wind power installation.

19. The Magnet system according to claim 2, wherein the guide holes or bore holes in the support are located in each of its two side surfaces and at regular or irregular angle intervals along its circumference.
